(19) United States
(12) Patent Application Publication
(10) Pub. No.: US 2014/0230906 A1
(43) Pub. Date: Aug. 21, 2014

(54) AUTOMATED FLUID REFILL SYSTEM AND USES THEREOF

(71) Applicant: LABORATORY CORPORATION OF AMERICA HOLDINGS, BURLINGTON, NC (US)

(72) Inventor: Robert Wayne Kays, Raleigh, NC (US)

(73) Assignee: LABORATORY CORPORATION OF AMERICA HOLDINGS, BURLINGTON, NC (US)

(21) Appl. No.: 14/348,646

(22) PCT Filed: Oct. 3, 2012
(86) PCT No.: PCT/US2012/058535

§ 371 Date: Mar. 31, 2014

Related U.S. Application Data
(60) Provisional application No. 61/542,892, filed on Oct. 4, 2011.

(51) Int. Cl. B01L 3/00

(52) U.S. Cl. CPC B01L 3/567
USPC 137/1; 137/412; 137/434

(57) ABSTRACT

The invention relates generally to laboratory systems that employ fluids, such as deionized water or other aqueous media. In particular, in certain embodiments, the invention provides automated systems for supplying fluids to laboratory equipment and uses thereof.

### CROSS-REFERENCE TO RELATED APPLICATIONS

The present application claims the benefit of priority to U.S. Provisional Patent Application No. 61/542,892, filed Oct. 4, 2011, which is incorporated by reference as though fully set forth herein.

### FIELD OF THE INVENTION

The invention relates generally to laboratory systems that employ fluids, such as deionized water or other aqueous media. In particular, in certain embodiments, the invention provides automated systems for supplying fluids to laboratory equipment and uses thereof.

### BACKGROUND

The use of fluids, such as water, including deionized water and other aqueous media, in chemistry, biochemistry, molecular biology, physics, genetics, virology, microbiology, biology and other sciences is often of the utmost importance. In chemistry and biochemistry, for example, experiments often use fluids such as water, aqueous systems or other known chemical fluids. Sometimes these experiments require large quantities of water and must be run over long periods of time. Moreover, because of the extended time periods over which these experiments are run, it is often not feasible for a scientist to monitor the experiment to ensure that fluid(s) are always available. Further, there are experiments done with instruments where large quantities of water and/or other aqueous fluids are also needed. These experiments may also be done over long periods of time. It would be advantageous to be able to procure these fluids so they can be used in experiments without having to stop or pause an experiment, or without having the stress of continually having to procure and monitor the fluids to ensure that there is an adequate supply. Additionally, it would be advantageous to be able to run a plurality of experiments with fluids without having to constantly procure the fluid from other locations but rather to have it constantly ready to use for the intended experiment.

Furthermore, many of the current liquid handling instruments on the market today (such as those sold by Tecan, Beckman, Qiagen, and others) employ the use of a liquid filled system. The instruments sometimes use a liquid column (for example, using deionized water) that extends from a source container, into an instrument which may have various pumps and syringes as part of the system and optionally may have (and in the case of washing/flushing liquid through) pipetting tips. The disadvantage of these instruments is that they are highly reliant on the availability of this fluid, and if the source container is allowed to run dry, various problems can ensue. These include, but are not limited to, inaccurate pipetting volumes, sample contamination and in many cases damage to the instrument valves and pumps (often due to the introduction of air into the instrument). Because these instruments are often quite expensive, repair or replacement costs are often prohibitive. It is with these limitations in mind that the present invention was developed.

### SUMMARY OF THE INVENTION

In at least one aspect, the invention provides fluid handling systems, comprising one or more fluid-holding containers, each fluid-holding container comprising: a fill valve connected to a fluid source, such that additional fluid flows into the container when the fill valve is at least partially open; a fluid level sensor, which comprises a float operationally connected to a lever, wherein the float is adapted to float on the surface of a fluid in the fluid-holding container; and a fluid exit line that is operationally connected a laboratory instrument; wherein the fluid level sensor is operationally connected to or in electrical communication with the fill valve, such that, the fill valve at least partially opens when the fluid level in the fluid-holding container falls below a first level and the fill valve closes when the fluid level in the fluid-holding container exceeds a second level, wherein the first level is lower than the second level.

In another aspect, the invention provides methods of maintaining a supply of fluid to a laboratory instrument, comprising: providing the fluid handling apparatus of any of the aspects and embodiments of the invention; withdrawing fluid from at least one of the one or more fluid-holding containers through the fluid exit line, thereby lowering the fluid level in the container; sensing that the fluid level in the container has fallen below a first level; at least partially opening the fill valve of the container in response to sensing that the fluid level in the container has fallen below a first level, thereby raising the fluid level in the container to a level above the first level.

Further aspects and embodiments of the invention are provided in the detailed description and the drawings.

### BRIEF DESCRIPTION OF DRAWINGS

The application includes the following figures. These figures are provided for illustrative purposes, and depict certain embodiments of the invention. The figures are not intended to limit the scope of the invention in any way.

FIG. 1 depicts a fluid-holding container and the related automated refill system, according to certain embodiments of the invention.

FIG. 2 depicts an automated refill system of some embodiments of the invention used with a liquid chromatography system.

### DETAILED DESCRIPTION

The following description recites various aspects and embodiments of the present invention. No particular embodiment is intended to define the scope of the invention. Rather, the embodiments merely provide non-limiting examples various compositions, apparatuses, and methods that are at least included within the scope of the invention. The description is to be read from the perspective of one of ordinary skill in the art; therefore, information well known to the skilled artisan is not necessarily included.

As used herein, the articles “a,” “an,” and “the” include plural referents, unless expressly and unequivocally disclaimed.

As used herein, the conjunction “or” does not imply a disjunctive set. Thus, the phrase “A or B is present” includes each of the following scenarios: (a) A is present and B is not present; (b) A is not present and B is present; and (c) A and B are both present. Thus, the term “or” does not imply an either/or situation, unless expressly indicated.

As used herein, the term “comprise,” “comprises,” or “comprising” implies an open set, such that other elements can be present in addition to those expressly recited.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The destruction of relatively expensive instruments can be a common occurrence in an analytical laboratory if a supply of fluid (e.g., deionized water or other aqueous media) is not continually made available to the instrument. This is particularly true where the instrument employs a pump system that pumps fluid into the instrument (e.g., into a chromatography column or other analytical apparatus). Thus, an automated fluid refill system has been designed and developed that continually refills the source container as fluid is removed from the container for use in various analytical experiments. One advantage of the present invention is that one does not need to monitor the fluid containing vessel(s) to verify that there is fluid in the vessel(s). Moreover, as fluid is withdrawn from the vessel, it is replaced by the same fluid, thereby making the procurement of said fluid a less frequent event. Accordingly, experiments will less frequently need to be stopped and/or paused. Moreover, this will likely add efficiency to the laboratory setting as the operator will be able to spend more time doing experiments and less time overseeing the maintenance of fluid levels in the supply reservoirs of various instruments.

In at least one aspect, the invention provides a fluid handling system, comprising one or more fluid-holding containers, each fluid-holding container comprising: a fill valve connected to a fluid source, such that additional fluid flows into the container when the fill valve is at least partially open; a fluid level sensor, which comprises a float operationally connected to a lever, wherein the float is adapted to float on the surface of a fluid in the fluid-holding container; and a fluid exit line that is operationally connected a laboratory instrument; wherein the fluid level sensor is operationally connected to or in electrical communication with the fill valve, such that, the fill valve at least partially opens when the fluid level in the fluid-holding container falls below a first level and the fill valve closes when the fluid level in the fluid-holding container exceeds a second level, wherein the first level is lower than the second level.

In some embodiments, the present invention relates to an automatic refill vessel and systems and methods relating thereto that can deliver liquids to laboratory instruments. The invention can be used in conjunction with a plurality of laboratory systems/instruments such as HPLC, LC, GC, fast reaction kinetics systems, and other systems that require the use of water and/or other liquids including mixtures of liquids. Anytime water is mentioned above and/or below, it should be understood that other liquids can equally be substituted for water and mixes of various liquids can also be substituted. Thus, one should not construe the use of the term “water” to mean that only water can be used. Rather, it should be understood that the system is designed so that any fluid can be used. It should also be understood that solutes may be solvated in these various liquids. Examples of solutes that can be solvated include buffers, salts, and any solid that has at least some solubility in the liquid(s) that are being used. In an embodiment, the liquid may be heated to increase the solubility of the solute. Alternatively and/or additionally to heating the fluid one or more co-fluids can be used to solvate the desired solute.

In some embodiments, the system contains a vessel (or a fluid-holding container) and a means of delivering precise quantity of water or other liquid to laboratory equipment. In some embodiments, the water or other liquid delivery is directly from the vessel via pipes that delivers water directly to laboratory equipment. In some such embodiments, a filter is placed in the line between the vessel and the instrument to which water or another liquid is to be delivered. In some embodiments, the vessel is automatically filled so that it maintains a constant volume of water or other liquid. As used herein, the term “constant volume” implies that the maximum volume of fluid within the fluid-holding container is never more than 50% greater, or 40% greater, or 30% greater, or 20% greater, or 10% greater than the minimum volume of fluid within the fluid-holding container, when the automated refill system is in operation.

In some embodiments, the systems and methods described herein are able to deliver precise quantities of fluid (e.g., water). In some embodiments, the quantity of water that can be delivered has a precision of ±100 mL, or ±50 mL, or ±25 mL, or ±10 mL, or ±5 mL, or ±1.0 mL, or ±0.5 mL, or ±0.2 mL, or ±0.1 mL, or ±0.05 mL, or ±0.02 mL, or ±0.01 mL.

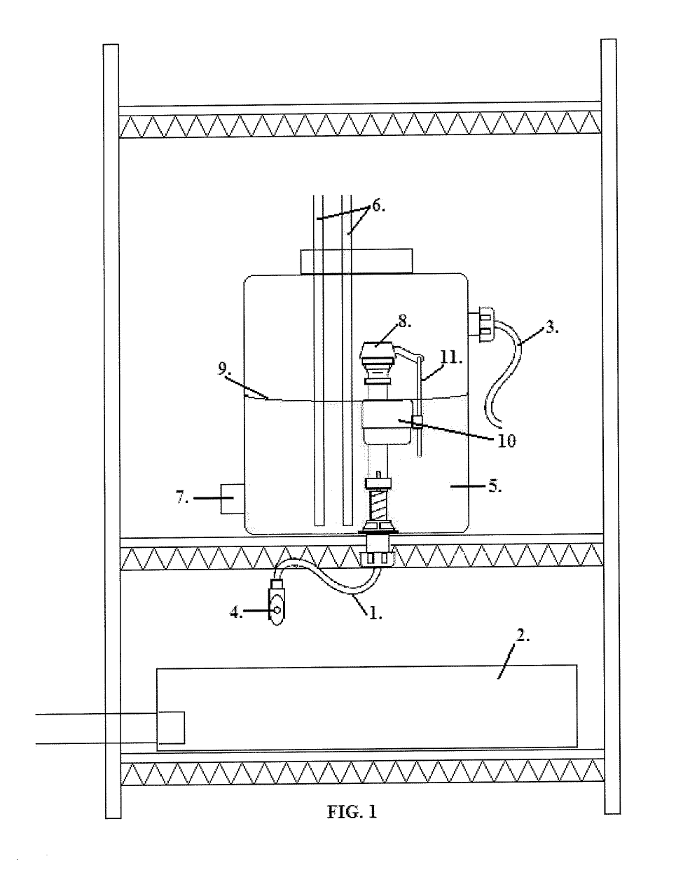

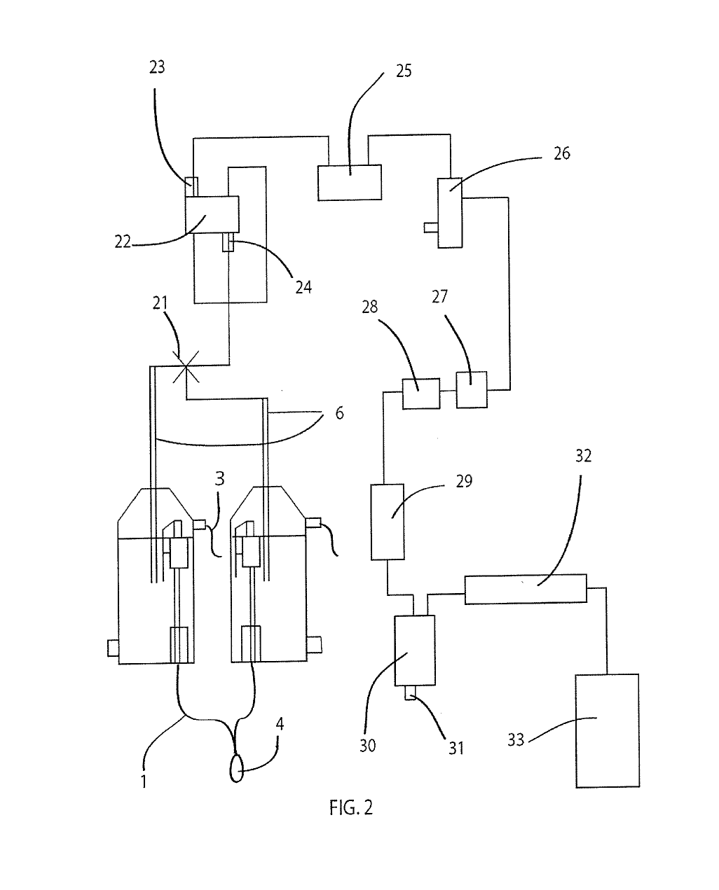

In some embodiments, such as those shown in FIG. 1, the system derives water from a spigot 4 that delivers deionized water through a source water line 1 to the container 12. It should be understood that although FIG. 1 refers to deionized water being delivered to the vessel, source water line 1 could just as easily deliver any other fluid. The invention is not limited to any particular source for the fluid used to refill the container. In some embodiments, the source of this refill fluid is a barrel or other vessel that is at a higher elevation than the container, thereby allowing fluid pressure to be sufficient to enter the vessel when the fill valve is open. Source water line 1 may contain a filter on it that filters the water or other liquid prior to its entrance into the vessel. Water line 1 delivers water to the top 8 of the fill valve housed in the vessel where it adds to water 5. As the water level 9 increases, float 10 also moves in conjunction with water level 9. The movement of float causes lever arm 11 to also move, which eventually turns off water being delivered to the vessel from the top 8 of the fill valve. The exit water lines 6 removes water 5 from the vessel and delivers it to instruments (not shown in FIG. 1 but an example is shown in FIG. 2). Generally, measuring pumps (not shown in FIG. 1, but shown in FIG. 2) will allow precise amounts of water to be delivered to the instruments. As water 5 is removed from the vessel, the water level decreases, which in turn opens the fill valve and water is again delivered to the vessel through the top 8 of the fill valve. A drain plug 7 prevents water 5 from leaking out of the vessel. If for some reason the fill valve fails to work as described and the water level 9 in the vessel rises until it reaches the exit port 12, the water level 9 will never exceed the level of exit port 12. Waste line 3 delivers this water to waste.

Although the exit lines 6 in FIG. 1 (and in FIG. 2) are shown as proceeding to only one instrument, it should be understood that valves may be placed on the exit lines so that the fluid that passes through the exit lines can go to any of plurality of instruments. As an example, an exit line may have a T valve type of system wherein lines go to two different instruments. By turning stopcocks or some other valve type of system, the fluid may be directed to one instrument and stopped from being delivered to the other instrument. Alternatively, the fluid may be delivered to both instruments. Although it has been described that the exit lines may go to two instruments, it should be understood that the exit lines may go to three, four, five, six, or more different instruments, all of which may have optional valves that can open or close the lines to those respective instruments allowing fluid to be delivered or not delivered to the respective instrument depending on whether the valve is open or closed.

It should be understood that these exit lines can be any of a plurality of materials including various polymers, stainless steel pipes, copper pipes, or any other known piping material that can be used to transport fluids. The system ideally will use a material for the exit lines that is suitable for the experiment that is being run. For example, if the experiment is being run at reduced pressure and/or at elevated temperature, the piping should be ideally suited to handle both high and reduced pressures as well as elevated temperature. As another example, if an acidic or basic solution is being used, the exit lines should be selected so that they do not react with the acid or base. In some embodiments, the lines are made of PVC.

In some embodiments, the system is housed in a stainless steel rack. Alternatively, any other rack that is known to those of skill in the art can be used. In a variation of this embodiment, the stainless steel rack or other rack may be located beneath the instrument.

As shown in FIG. 2, the vessel(s) of the present invention is/are shown with an HPLC (high pressure liquid chromatography) system. In FIG. 2, deionized water is being delivered to the vessel from the spigot 4 by source water line 1 and a second vessel with a second fluid has that second fluid delivered by second fluid line. Although the source for second fluid line is shown as spigot 4, it should be understood that a second spigot or other source may be utilized. Alternatively, it may be withdrawn from a barrel containing the fluid present in the vessel. Alternatively, it can be any other fluid containing container that holds sufficient fluid to replenish the vessel. In an embodiment that is not shown in FIG. 2, it should be understood that prior to entering the vessel from second fluid line, the fluid may be dried so that it does not contain water and/or filtered and/or distilled so that it is pure and does not contain impurities. Drying may occur via molecular beads or by any other known drying means such as, for example, the presence of magnesium sulfate. In certain embodiments, the fluid may pass through charcoal filters or other filters known to remove un-wanted impurities. In certain embodiments, second fluid line may also be the distillate from a distillation so that it is relatively pure (or, alternatively, may be a known co-distillate and/or azeotrope).

Exit fluid lines 6 can deliver a mix of deionized water and the second fluid (which is fed by second fluid line) to the HPLC system. Although one of the vessels is shown as being fed with and containing deionized water, it should be understood that any fluid can be used on each and/or both of the vessels shown. For example, it is possible that methanol may be one of the fluids and ethyl acetate the other. Other commonly used fluids may be used and include alcohols, ethers, aldehydes, ketones, esters, carboxylic acids, hydrocarbons (including alkyl, alkenyl and alkynyl hydrocarbons), amines and amino-containing fluids (such as ureas), imines, amides, fluids containing halogens including halogenated hydrocarbon fluids, cyano- and nitrile-containing fluids, nitro containing fluids, sulfides, sulfoxides, sulfones, carbocyles, aryls, heterocycles, heteroaryls, acids, bases, buffers, or any combination thereof including mixtures of fluids. It should also be understood that although two vessels are shown in FIG. 2, it is contemplated and therefore within the scope of the invention that any number of vessels can be used. For example, different embodiments use three, four, five, or more vessels. In the embodiment shown in FIG. 2, pump 22 pulls fluid out of the vessels using exit fluid lines 6. Fluid proportionating valve 21 controls the amount of each of the respective fluids that are fed from exit fluid lines 6. For example, if a 3-to-1 mixture of water/ethyl acetate is desired, the fluid proportionating valve will pull 3 times the volume of water relative to the ethyl acetate that may be present in the second vessel. It should be understood that the fluid proportionating valve can have any number of vessels connected to it so that a plurality of different fluids can be used. For example, there may be up to 10 (or more) vessels that hold fluid.

As was described with regard to FIG. 1, the fluid is replenished as it is withdrawn. In an embodiment, pump 22 in conjunction with fluid proportionating valve 21 can withdraw precise amounts of fluid from each of the respective vessels. As was described with regard to FIG. 1, in an embodiment, the amount of fluid present in the vessel does not vary greatly so that the fluid level stays relatively constant. After the fluid(s) is/are withdrawn from the vessels, the fluid passes through inlet check valve 24 and passes through the outlet check valve 23. In an embodiment, these check valves serve to allow precise amounts of liquid to be delivered. Subsequently, the fluid passes through an optional pulse damper 25 to the primer component 26. Subsequently, an optional filter 27 (or optionally, a plurality of filters may be present). A back pressure regulator 28 is optionally present that regulates the back pressure. A pressure transducer 29 may also optionally be present insuring the pressure that will be present in the column is sufficient to get good separation of the sample components. Fluid and sample mixture is where the sample is introduced into sample injector valve 31. The sample/fluid mixture proceeds through column 32 prior to reaching detector 33. Although not shown in FIG. 2, it should be understood that the separated sample can be collected in fractions once it passes through column 32 and/or detector 33.

In some embodiments, the fluid-holding container is made of plastic, glass, metal, various polymers or any other material that is suitable for holding liquids. For example, if acids are to be held, the appropriate container that will not disintegrate and/or react with acids should be used. The fluid-holding container can be of any suitable size. For example, in some embodiments, the fluid-holding container has a volume of from 0.1 L to 250 L, or from 1 L to 50 L. In some embodiments, the fluid-holding container is a 20-L carboy.

In some embodiments, the present invention may be done so that there is no oxygen present in the system. The system may be done under an inert gas system such as argon or nitrogen, or alternatively, using helium, neon, nitrogen, argon, krypton, xenon, or sulfur hexafluoride. Moreover, the system may the means of the removing impurities from the fluid(s) used in the system such as the removal of oxygen by using techniques known by those of skill in the art such as those disclosed in Purification of Laboratory Chemicals, Perrin et al., 4^{th} edition, 2000, Pergamon Press, the entire contents of which are incorporated in its entirety for all purposes. Thus, modifications to the system may incorporate these methods directly into the system. For example, molecular sieves may be present in the vessel, or may be a part of the system as the fluid makes its way to the vessel or exits the vessel. Similarly, other chemicals or means of purifying the fluid(s) may be a part of the system.

In some embodiments, there may be an alarm associated with the vessel system that lets the user know when fluid levels in the vessel are not being replenished to the level of fluid that was present prior to fluid being removed from the exit fluid lines. The alarm may be audible or visible, or both. The alarm may be present in any of a plurality of places (such as even at the source. For example, if a barrel containing ethyl acetate is empty, the alarm may sound letting the user know that the barrel needs to be replaced (or alternatively, more ethyl acetate needs to be added to the barrel). In certain embodiments, the alarm may notify the user remotely such as on a computer screen at a remote location. In certain embodiments when a plurality of vessels are used, the alarm may be sophisticated enough the let the user know what fluid needs to be replaced. Moreover, in a variation, the system may sophisticated enough to let the user know exactly how much fluid remains at each and all of the sources (e.g., similar to an automobile's gas tank).

In certain embodiments, there may be temperature changing or temperature maintaining apparatuses associated with the vessel. For example, if experiments are to be run at temperatures other than room temperature, heaters or means of cooling the fluid in the vessel may be used. For example, if the vessel is to be used in conjunction with a NMR instrument, the vessels may contain liquid nitrogen and or liquid helium to keep the superconducting magnet from quenching and the appropriate insulation jackets should be present around the vessels to keep the liquid nitrogen/helium from boiling off too quickly. Similarly, if experiments are to be run at temperatures above room temperature, the appropriate heaters and insulation jackets may be used in conjunction with the vessels to arrive at the desired temperature. In certain embodiments, the system can be used for liquid systems at temperatures around the boiling point of liquid helium (˜4K at 1 atmosphere) to temperatures that are hotter than the boiling point of water (100° C. at 1 atmosphere).

In certain embodiments, the system may be used at high or reduced pressure. Accordingly, the vessels and the system should be engineered so that the system can be used at high and low pressures including the structural integrity of the various component parts of the system. For example, it is contemplated and therefore within the scope of the invention, that the system can be used at pressures as low as 10⁻³ mbar or at pressures as high as 10,000 atmospheres. Alternatively, ultra-low and ultra-high pressures may be used including pressures as low as 10⁻⁶ mbar or at pressures as high as 100,000 atmospheres. Accordingly, the system should contain sufficient structural strength to accommodate these pressures. For example, the system may be reinforced with various hard metals such as stainless steel or titanium or carbon composites able to handle high and low pressures. It is noted that at ultra-high pressures (both high and low) that the fluids that can be effectively used are more limited and the experimental system may need to be modified to accommodate these pressures.

In some embodiments, the present invention relates to laboratory equipment that contains the fluid containing/dispersing vessel with automatic replenishment. In some embodiments, any laboratory equipment that uses fluid can be used, including but not limited to ESR, NMR (e.g., liquid nitrogen/helium or kinetic related experiments), chromatography, fast mixing kinetics or regular kinetic experiments, cyclic voltammetry and other electrochemical techniques, chemical reactions (e.g., reactions where fluid is lost and must be replaced), UV-Vis spectroscopy experiments, Atomic absorption spectroscopy, IR spectroscopy, Raman spectroscopy, fluorescence and/or phosphorescence spectroscopy, emission spectroscopy, x-ray spectroscopy, electron spectroscopy, radiochemical methods, mass spectroscopy, potentiometric methods, coulometric methods, polarography, conductometric methods, and/or thermal methods. In a variation, if the system is used in the chromatography arena, the system can be used on systems that include but are not limited to liquid chromatography such as size exclusion, molecular exclusion, ion exchange, reverse phase, affinity chromatography, HPLC, adsorption chromatography, partition chromatography, thin layer chromatography) and gas chromatography. The system may be appropriately modified for the particular experiment that is being run.

In certain embodiment, the present invention is directed to systems, methods, processes, apparatuses, instruments or other products that use the fluid filling vessel of the present invention.

In certain embodiments, the present invention relates to a system for automatically replenishing fluid in one or more containers wherein the one or more containers each comprise at least one fill valve wherein the at least one fill valve comprises a float and a lever arm wherein the float and the lever arm are operationally connected, wherein when fluid is removed from the container through exit fluid lines, additional fluid is fed into the container through the at least one fill valve, wherein a decreased fluid level in the container causes the float to float on the fluid at the decreased fluid level, causing the lever arm to open a valve in the at least one fill valve allowing fluid to enter the container, and as the fluid level increases the float floats on the fluid, causing the lever arm to begin closing the valve in the at least one fill valve until an increased fluid level is reached wherein the valve closes.

In a variation the fluid may be water. In a variation, the additional fluid that is added to the one or more containers may come from a spigot or barrel. In a variation, the exit fluid lines may be operationally connected to a chromatography column and/or instrument. In a variation, the chromatography column and/or instrument is an HPLC instrument.

In a variation, the HPLC instrument has a pump that allows precise quantities of fluid to be removed from the container. In a variation, precise quantities of fluid may be deliverable with an error bar off 0.01 mL. In a variation the one or more containers may be made out of plastic, glass, or metal.

In an embodiment, more than one container is used. In an embodiment, precise quantities of fluid are deliverable from each container with an error bar of ±0.01 mL.

In at least another aspect, the invention provides methods of maintaining a supply of fluid to a laboratory instrument, comprising: providing the fluid handling apparatus of any of the aspects and embodiments of the fluid refill system (described above); withdrawing fluid from at least one of the one or more fluid-holding containers through the fluid exit line, thereby lowering the fluid level in the container; sensing that the fluid level in the container has fallen below a first level; at least partially opening the fill valve of the container in response to sensing that the fluid level in the container has fallen below a first level, thereby raising the fluid level in the container to a level above the first level. In some embodiments, the methods further comprise: sensing that the fluid level in the container has risen above a second level; and closing the fill valve of the container in response to the sensing that the fluid level in the container has risen above a second level.

In some embodiments, the method comprises: feeding additional fluid into the container through at least one fill valve while fluid is removed from the container through exit fluid lines,

wherein the at least one fill valve comprises a float and a lever arm wherein the float and the lever arm are operationally connected, wherein when fluid is removed from the container a decreased fluid level in the container causes the float to float on the fluid at the decreased fluid level, causing the lever arm to open a valve in the at least one fill valve allowing the additional fluid to enter the container, and as the fluid level increases the float floats on the fluid, causing the lever arm to begin closing the valve in the at least one fill valve until the fluid is replenished and the lever arm causes the valve to close.

In a variation of the method, the fluid may be water. In a variation, the additional fluid that is added to the one or more containers may come from a spigot or barrel. In a variation, the exit fluid lines may be operationally connected to a chromatography column and/or instrument. In a variation, the chromatography column and/or instrument is a HPLC instrument.

In a variation of the method, the HPLC instrument has a pump that allows precise quantities of fluid to be removed from the container. In a variation, precise quantities of fluid may be deliverable with an error bar of ±0.01 mL. In some embodiments, the one or more containers may be made out of plastic, glass, or metal.

In an embodiment, more than one container is used. In some embodiments, precise quantities of fluid are deliverable from each container with an error bar of ±0.01 mL.

The invention is not limited to any particular method of sensing the fluid levels, so long as it is consistent with other features of the invention. In some embodiments, the sensing is carried out by mechanical means. In other embodiments, it is carried out by electro-mechanical means.

It should be understood that is contemplated and therefore within the scope of the invention that any above-disclosed element of the invention as described herein can be combined with any other disclosed element of the invention or any combination of elements can be combined with any element or combination of elements as described herein. For example, the system may be appropriately designed so that it is able to handle high and low pressures, high and low temperatures, and be used for any of a variety of purposes as discussed above. In any event, the invention is to be defined by the below claims.

1. A fluid refill system, comprising one or more fluid-holding containers, each fluid-holding container comprising:
a fill valve connected to a fluid source, such that additional fluid flows into the container when the fill valve is at least partially open;
a fluid lever sensor, which comprises a float operationally connected to a lever, wherein the float is adapted to float on the surface of a fluid in the fluid-holding container; and
a fluid exit line is operationally connected to a laboratory instrument;
wherein the fluid level sensor is operationally connected to or in electrical communication with the fill valve such that the fill valve at least partially opens when the fluid level in the fluid-holding container falls below a first level and the fill valve closes when the fluid level in the fluid-holding container exceeds a second level, wherein the first level is lower than the second level.

2. The fluid refill system of claim 1, wherein the fluid source is a spigot, a tank, or a barrel.

3. The fluid refill system of claim 1, wherein the laboratory instrument is an instrument that employs a fluid pump.

4. The fluid refill system of claim 3, wherein the laboratory instrument is a liquid chromatography system.

5. The fluid refill system of claim 1, wherein the system is adapted to deliver a volume of fluid with an error of no more than ±0.01 mL.

6. The fluid refill system of claim 1 wherein the one or more fluid-holding containers are made of plastic, glass, or metal.

7. The fluid refill system of claim 1, wherein the system comprises two or more fluid-holding containers.

8. A fluid refill system of claim 1, wherein the fluid level sensor is operationally connected to the fill valve.

9. A method of maintaining a supply fluid to a laboratory instrument, comprising:
providing the fluid refill system of claim 1;
withdrawing fluid from at least one of the one or more fluid-holding containers through the fluid exit line, thereby lowering the fluid level in the container;
sensing that the fluid level in the container has fallen below a first level;
at least partially opening the fill valve of the container in response to sensing that the fluid level in the container has fallen below a first level, thereby raising the fluid level in the container to a level above the first level.

10. The method of claim 9, further comprising:
sensing that the fluid level in the container has risen above a second level; and
closing the fill valve of the container in response to the sensing that the fluid level in the container has risen above a second level.

11. The method of claim 9, wherein the fluid is deionized water.
